(19) United States
(12) Patent Application Publication
(10) Pub. No.: US 2025/0046091 A1
(43) Pub. Date: Feb. 6, 2025

(54) TRAFFIC IMAGE SENSOR MOVEMENT DETECTION AND HANDLING

(71) Applicant: GridMatrix, Inc., Cupertino, CA (US)

(72) Inventors: Eric Valasek, Palo Alto, CA (US); Eric Wendt, Fort Collins, CO (US)

(21) Appl. No.: 18/753,984

(22) Filed: Jun. 25, 2024

Related U.S. Application Data
(60) Provisional application No. 63/530,897, filed on Aug. 4, 2023.

(51) Int. Cl. G06V 20/54; G06T 7/194; G06V 10/25

(52) U.S. Cl. CPC G06V 20/54; G06T 7/194; G06V 10/25

(57) ABSTRACT

One or more devices perform traffic image sensor movement detection and handling. Moving objects may be removed from first and second images, background extraction may be performed on the first and second images, one or more structural features may be mapped in the first and second images, and a translation between the first and second images may be estimated. If the translation is above a threshold amount, an action may be taken. In some examples, vehicles may be masked out using a mask segmentation model, background extraction may be performed, a homography transform may be performed, and a translation may be estimated.

### CROSS-REFERENCE TO RELATED APPLICATION

This application is a nonprovisional and claims the benefit under 35 U.S.C. § 119(e) of U.S. Provisional Patent Application No. 63/530,897, filed Aug. 4, 2023, titled “Traffic Image Sensor Movement Detection and Handling”, the contents of which are incorporated herein by reference as if fully disclosed herein.

### FIELD

The described embodiments relate generally to traffic analysis. More particularly, the present embodiments relate to traffic image sensor movement detection and handling.

### BACKGROUND

All population areas experience traffic. Traffic may be motorized, non-motorized, and so on. Traffic may include cars, trucks, pedestrians, scooters, bicycles, and so on. Traffic appears to only increase as the population of the world continues to increase.

Some population areas, such as cities, use cameras and/or other traffic monitoring devices to capture data about traffic. This data may be used to evaluate congestion, traffic signal configurations, road layout, and so on.

### SUMMARY

The present disclosure relates to traffic image sensor movement detection and handling. Moving objects may be removed from first and second images, background extraction may be performed, one or more structural features may be mapped, and a translation may be estimated. If the translation is above a threshold amount, an action may be taken. In some examples, vehicles may be masked out using a mask segmentation model, background extraction may be performed, a homography transform may be performed, and a translation may be estimated.

### BRIEF DESCRIPTION OF THE DRAWINGS

The disclosure will be readily understood by the following detailed description in conjunction with the accompanying drawings, wherein like reference numerals designate like structural elements.

FIG. 1A depicts a first example first image from a traffic sensor.

FIG. 1B depicts first example second image from the traffic sensor.

FIG. 1C depicts the first example second image of FIG. 1B with an indicator illustrating the position from the first example first image of FIG. 1A.

FIG. 2A depicts a second example first image from a traffic sensor.

FIG. 2B depicts second example second image from the traffic sensor.

FIG. 3A depicts a third example first image from a traffic sensor.

FIG. 3B depicts third example second image from the traffic sensor.

FIG. 4A depicts a fourth example first image from a traffic sensor.

FIG. 4B depicts fourth example second image from the traffic sensor illustrating a big movement from the fourth example first image of FIG. 4A.

FIG. 4C depicts an alternative fourth example second image illustrating a small movement from the fourth example first image of FIG. 4A and an indicator illustrating the position from the fourth example first image of FIG. 4A.

FIG. 5A depicts a fifth example first image from a traffic sensor including an area of interest.

FIG. 5B depicts fifth example second image from the traffic sensor illustrating a changed position of the area of interest.

FIG. 6 depicts a flow chart illustrating a first example method for traffic image sensor movement detection and handling. This method may be performed by the systems of FIGS. 9 and/or 10.

FIG. 7 depicts a flow chart illustrating a second example method for traffic image sensor movement detection and handling. This method may be performed by the systems of FIGS. 9 and/or 10.

FIG. 8A depicts a flow chart illustrating a third example method for traffic image sensor movement detection and handling. This method may be performed by the systems of FIGS. 9 and/or 10.

FIG. 8B depicts an image after performance of MaskRCNN segmentation.

FIG. 8C depicts the image of FIG. 8B after removal of foreground moving objects.

FIG. 8D depicts an image after performance of Yolo7 segmentation.

FIG. 8E depicts the image of FIG. 8D after removal of foreground moving objects.

FIG. 9 depicts a block diagram of a system for traffic image sensor movement detection and handling.

FIG. 10 depicts a diagram of a cloud architecture system for traffic image sensor movement detection and handling.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Data from traffic image sensors, such as sequential still images or frames of video from intersection cameras, may be analyzed to determine various information about traffic. This may include traffic congestion, accidents, traffic speed, and so on. This information may be used for a variety of purposes, such as traffic signal control, responding to emergency conditions, route planning, road changes, and so on.

Traffic image sensors may not be fixed in position. Instead, such traffic image sensors may be panned, tilted, zoomed, and/or otherwise moved. This movement may be intentional, such as when the traffic image sensor is moved by an operator and/or an automatic system control, or may be accidental, such as when the traffic image sensor drifts, is blow by wind, is vibrated, is bumped into, and/or otherwise accidentally moved.

Movement of the traffic image sensor may change the field of view between sequential still images or frames of video. This movement may cause issues for the analysis that uses such sequential still images or frames of video. In some cases, the movement may be small enough that there is no problem and the movement can be ignored. In other cases, the movement may be small enough that the sequential still images or frames of video can still be used for analysis, but the movement may need to be corrected for in order for the analysis to be sufficiently accurate. In still other cases, the movement may be big enough that the sequential still images or frames of video should not be used for analysis.

For example, one or more areas of interest, such as an intersection, may be defined within the sequential still images or frames of video. The movement may small enough that the area of interest is still present and the sequential still images or frames of video may still be used for analysis, whether or not an adjustment may need to be made for the analysis to account for the new position of the area of interest. However, the movement may be big enough that the area of interest is no longer present in the sequential still images or frames of video and the sequential still images or frames of video should not be used for analysis.

The following disclosure relates to traffic image sensor movement detection and handling. Moving objects may be removed from first and second images, background extraction may be performed, one or more structural features may be mapped, and a translation may be estimated. If the translation is above a threshold amount, an action may be taken. In some examples, vehicles may be masked out using a mask segmentation model, background extraction may be performed, a homography transform may be performed, and a translation may be estimated.

In this way, a system using the techniques of the present disclosure may be able to detect and/or handle traffic image sensor movement. Further, by using the techniques of the present disclosure the system may be able to perform this in a way that is more robust while using less hardware and software resources than other ways of detecting and/or handling traffic image sensor movement. This technological improvement may enable the system to perform functions that the system would not previously have been able to perform absent the technology disclosed herein. This may also enable the system to operate more efficiently while consuming fewer hardware and/or software resources as more resource consuming techniques could be omitted. Further, a variety of components may be omitted while still enabling traffic image sensor movement detection and handling, reducing unnecessary hardware and/or software components, and providing greater system flexibility.

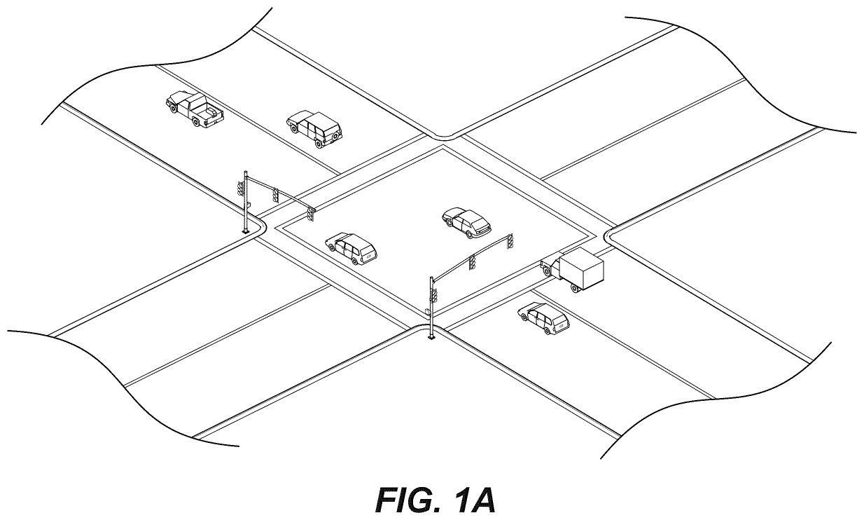

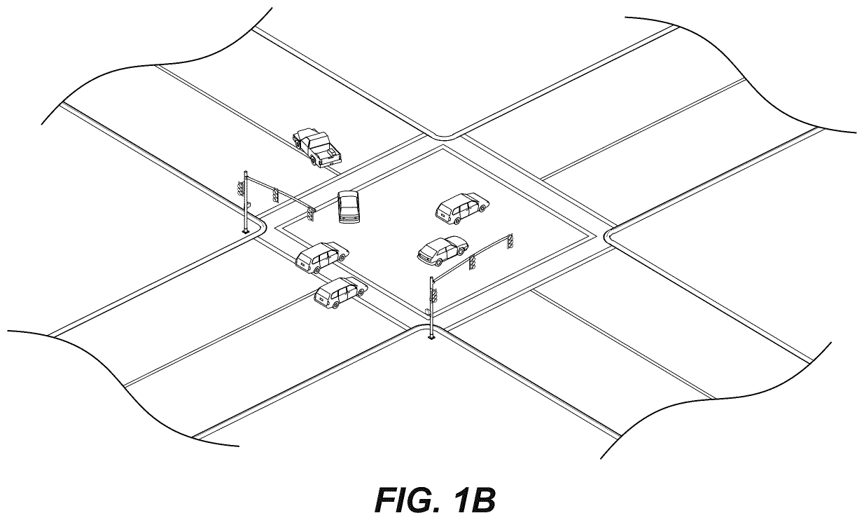

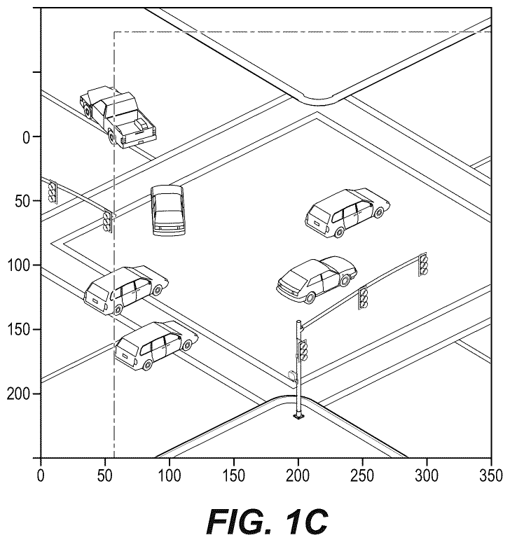

These and other embodiments are discussed below with reference to FIGS. 1-10. However, those skilled in the art will readily appreciate that the detailed description given herein with respect to these Figures is for explanatory purposes only and should not be construed as limiting.

FIG. 1A depicts a first example first image from a traffic sensor. The first example first image corresponds to an intersection with vehicles moving through it. The first example first image may be from a series of sequential still images, video frames, and so on.

FIG. 1B depicts first example second image from the traffic sensor. The first example second image may be from the same series of sequential still images, video frames, and so on as the first example first image. However, as shown, the field of view has changed due to movement of the traffic image sensor that captured the first example first image and the first example second image.

FIG. 1C depicts the first example second image of FIG. 1B with an indicator illustrating the position from the first example first image of FIG. 1A. In this example, the indicator comprises a rectangle showing the portion of the first example second image that corresponds to the first example first image. As not all of the first example first image is present in the first example second image, the rectangle is incomplete in the first example second image.

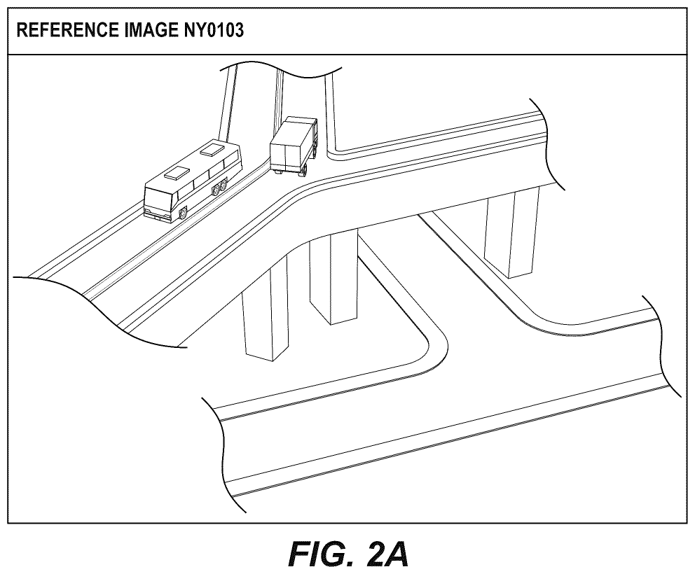

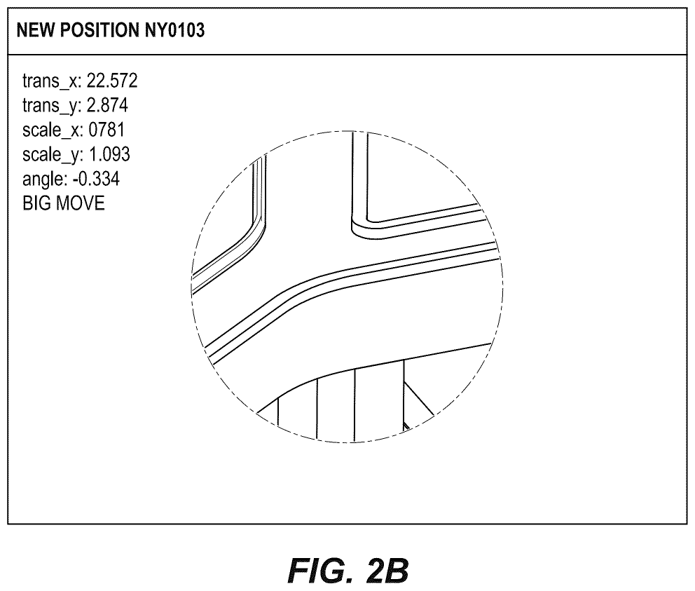

FIG. 2A depicts a second example first image from a traffic sensor. FIG. 2B depicts second example second image from the traffic sensor. As shown, the second example second image includes an indictor showing the amount of translation between the second example first image of FIG. 2A and the second example second image. As shown, this includes a translation in the x dimension (which may correspond to tilt and/or up/down vertical axial movement of the traffic image sensor that captured the images), a translation in the y dimension (which may correspond to pan and/or left/right lateral axial movement of the traffic image sensor that captured the images), x and y scale (which may correspond to zoom of the traffic image sensor that captured the images, and angle. The translations may be expressed in pixels to indicate absolute pixel movement.

As also shown the indicator may include whether the translation is a big move or is considered good. The translation may be a big move when the translation is big enough that the images cannot be used. In such a case, the images may be flagged to not be used, a notification may be sent not to use the images, and so on. The translation may be considered good when the translation is small enough that the images can still be used, whether or not with adjustment for the translation. Whether or not the translation is big enough or small enough may depend on whether an area of interest is still present, the amount of the movement (such as where the field of view moves more than ten feet, 100 pixels, and so on). In this example, the translation is a big move.

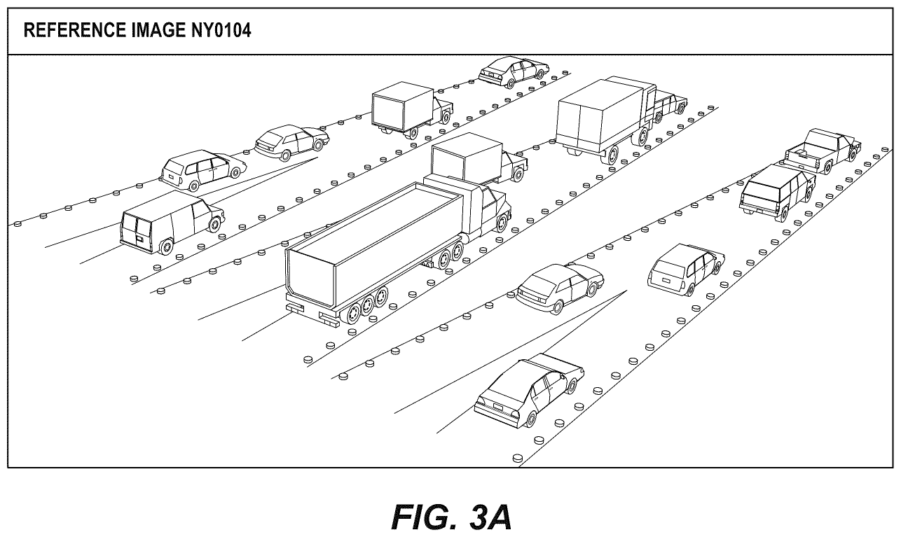

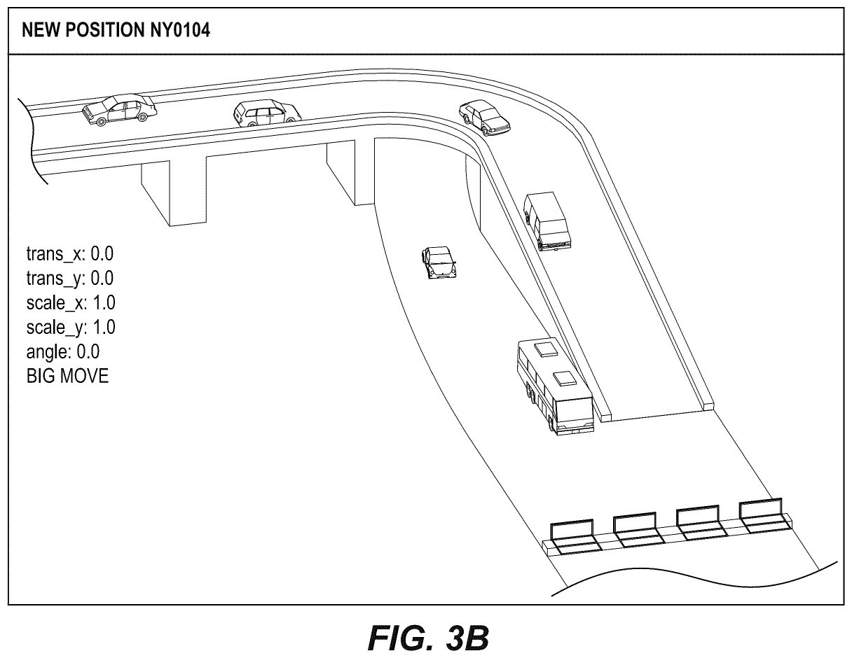

FIG. 3A depicts a third example first image from a traffic sensor. FIG. 3B depicts third example second image from the traffic sensor. Like in FIGS. 2A and 2B, the translation between the third example first image of FIG. 3A and the third example second image is a big move.

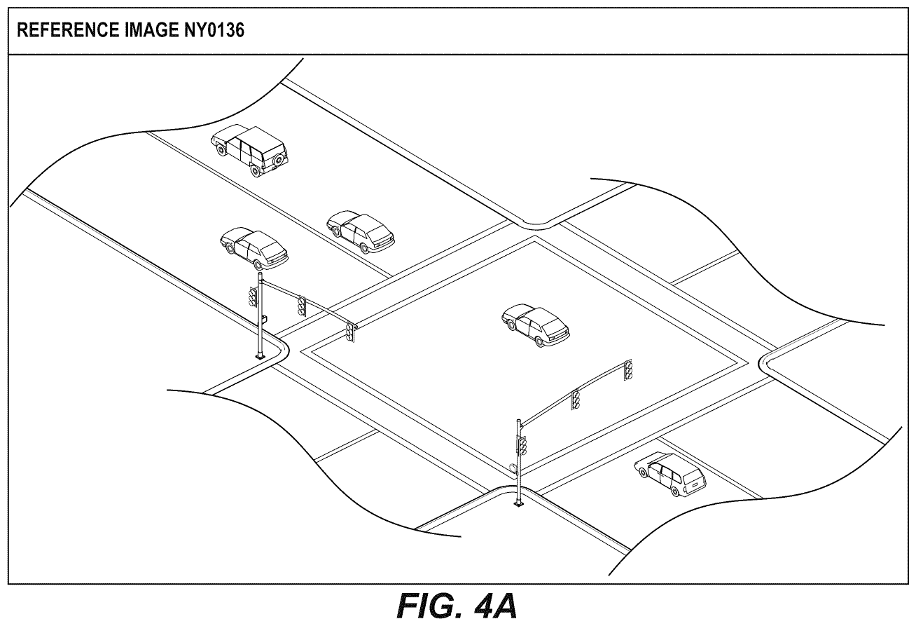

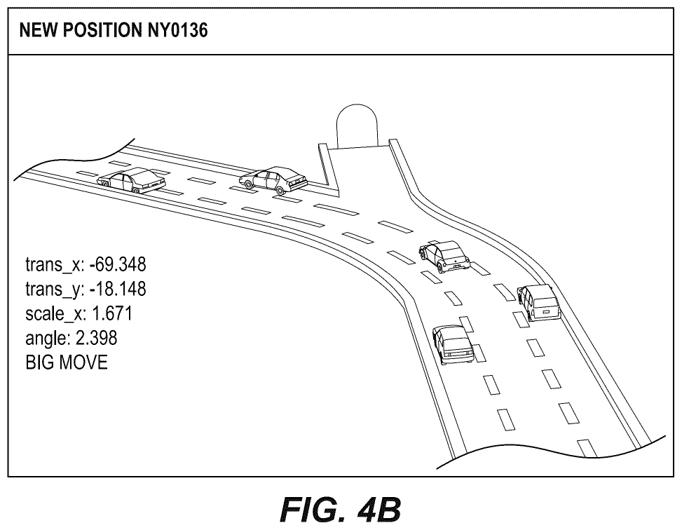

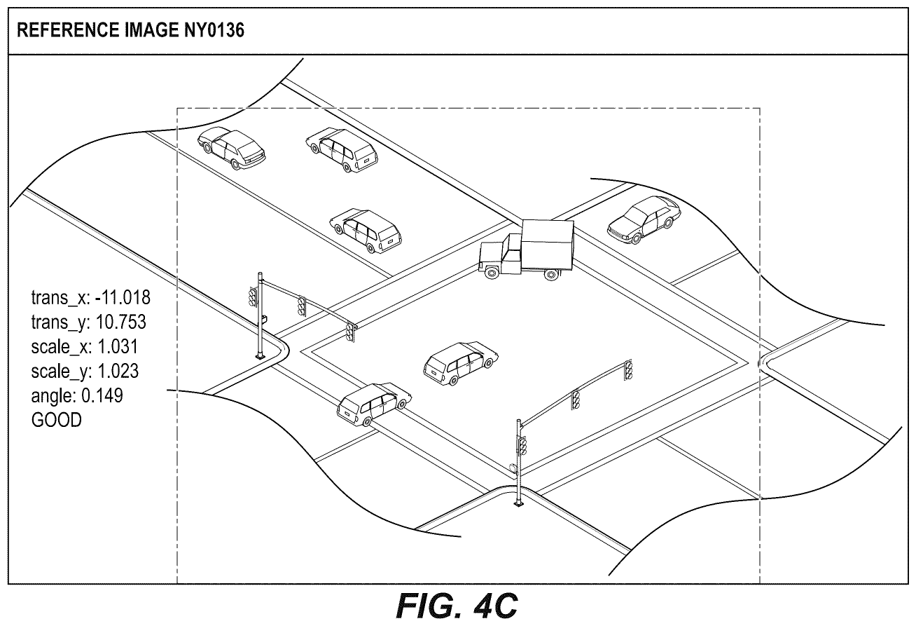

FIG. 4A depicts a fourth example first image from a traffic sensor. FIG. 4B depicts fourth example second image from the traffic sensor illustrating a big movement from the fourth example first image of FIG. 4A. Like in FIGS. 2A and 2B and FIGS. 3A and 3B, the translation between the fourth example first image of FIG. 4A and the fourth example second image is a big move.

FIG. 4C depicts an alternative fourth example second image illustrating a small movement from the fourth example first image of FIG. 4A and an indicator illustrating the position from the fourth example first image of FIG. 4A. Unlike in FIGS. 2A and 2B, FIGS. 3A and 3B, and FIGS. 4A and 4B, the translation between the fourth example first image of FIG. 4A and the alternative fourth example second image is considered because the translation is small enough.

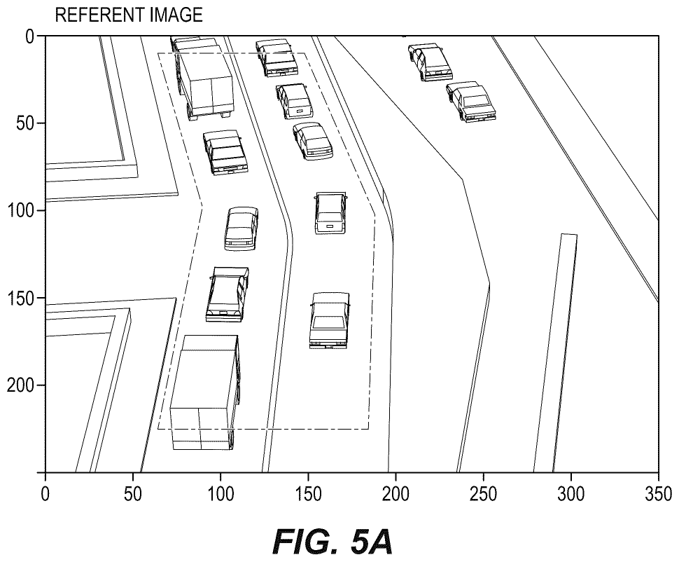

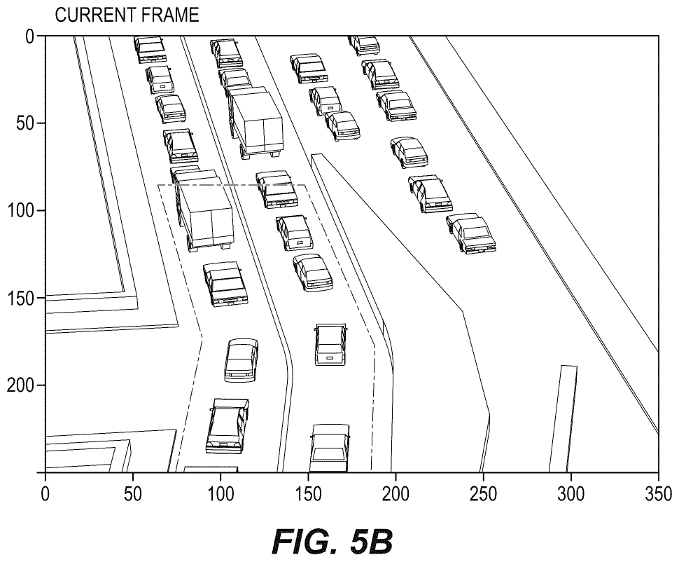

FIG. 5A depicts a fifth example first image from a traffic sensor including an area of interest. In this example, the area of interest includes an intersection, approaches into the intersection, and exits from the intersection.

FIG. 5B depicts fifth example second image from the traffic sensor illustrating a changed position of the area of interest.

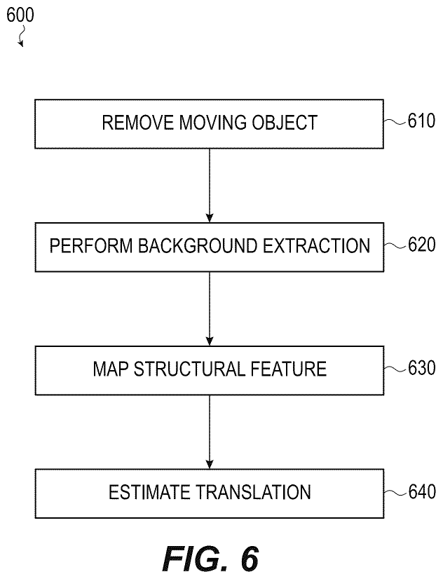

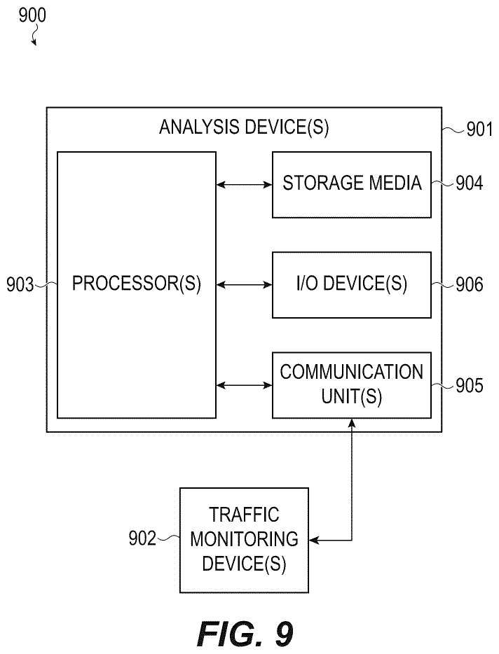

FIG. 6 depicts a flow chart illustrating a first example method for traffic image sensor movement detection and handling. This method may be performed by the systems of FIGS. 9 and/or 10.

At operation 610, an electronic device (such as the analysis device 901 of FIG. 9) may remove moving objects from a first image and a second image. At operation 620, the electronic device may perform background extraction on the first and second images.

These operations 610 and 620 may enable location of a feature that will enable estimation of a translation between the two images. Moving objects may be too transient to be useful for such translation estimation. Background features, such as structural features (like roads, intersections, crosswalks, traffic signals, signs, and so on), may be more useful for such translation estimation due to their fixed nature. Removing moving objects and extracting the background of the images may aid in identifying structural features that may be mapped between the images and then used to estimate a translation.

In some examples, one or more of these operations 610 and 620 may be performed by masking out vehicles and/or other moving objects using a mask segmentation model and then removing the masked out objects. Such a mask segmentation model may be DeepLab, MaskRCNN, Yolov7, Yolov8, and so on.

At operation 630, the electronic device may map a structural feature between the first and second images. At operation 640, the electronic device may estimate a translation using the mapping of the structural feature between the first and second images.

In various examples, this example method 600 may be implemented as a group of interrelated software modules or components that perform various functions discussed herein. These software modules or components may be executed within a cloud network and/or by one or more computing devices, such as the analysis device 901 of FIG. 9.

Although the example method 600 is illustrated and described as including particular operations performed in a particular order, it is understood that this is an example. In various implementations, various orders of the same, similar, and/or different operations may be performed without departing from the scope of the present disclosure.

For example, operation 630 is illustrated and described as mapping using a structural feature. However, it is understood that this is an example. In various implementations, features other than structural features may be used. Various configurations are possible and contemplated without departing from the scope of the present disclosure.

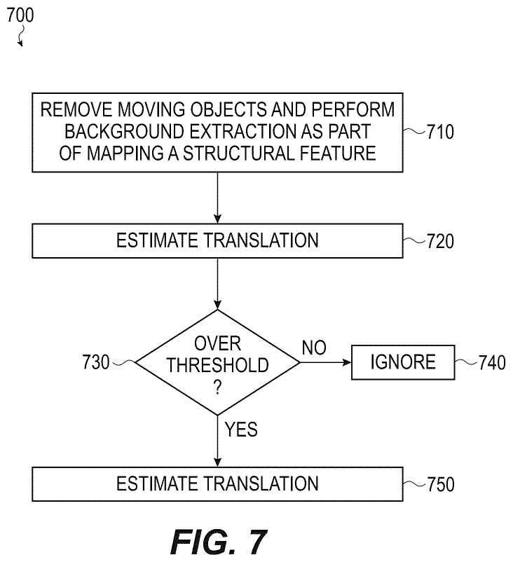

FIG. 7 depicts a flow chart illustrating a second example method for traffic image sensor movement detection and handling. This method may be performed by the systems of FIGS. 9 and/or 10.

At operation 710, an electronic device (such as the analysis device 901 of FIG. 9) may remove moving objects (such as vehicles, pedestrians, and so on) and perform background extraction as part of mapping a structural feature between a first image and a second image. At operation 720, the electronic device may estimate a translation between the first image and the second image using the mapping.

At operation 730, the electronic device may determine whether or not the translation is over a threshold amount (such where the field of view moves more than an amount (such as ten feet, 100 pixels, and so on), or the like). If not, the flow may proceed to operation 740 where the electronic device may ignore the translation. Otherwise, at operation 750, the electronic device may take an action. The action may include flagging data associated with the traffic image sensor as not to be used (whereupon in some implementations the data may be unflagged upon estimating that the translation is reversed), transmitting an instruction to move the traffic image sensor (such as to the image sensor), compensating for the translating when using data associated with the traffic image sensor for analysis, outputting information about the translation (such as on the second image) (such as an indicator showing an amount of the translation, a position of the first image in the second image, and so on), and/or otherwise handling the translation.

In various examples, this example method 700 may be implemented as a group of interrelated software modules or components that perform various functions discussed herein. These software modules or components may be executed within a cloud network and/or by one or more computing devices, such as the analysis device 901 of FIG. 9.

Although the example method 700 is illustrated and described as including particular operations performed in a particular order, it is understood that this is an example. In various implementations, various orders of the same, similar, and/or different operations may be performed without departing from the scope of the present disclosure.

For example, operation 730 is illustrated and described in the context of a threshold amount. However, it is understood that this is an example. In some implementations, an evaluation of whether an area of interest is still present may be used instead. Various configurations are possible and contemplated without departing from the scope of the present disclosure.

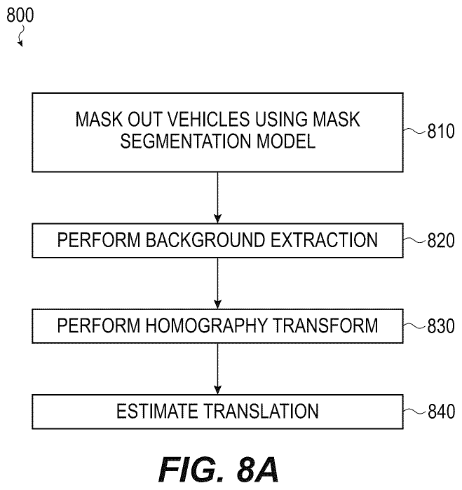

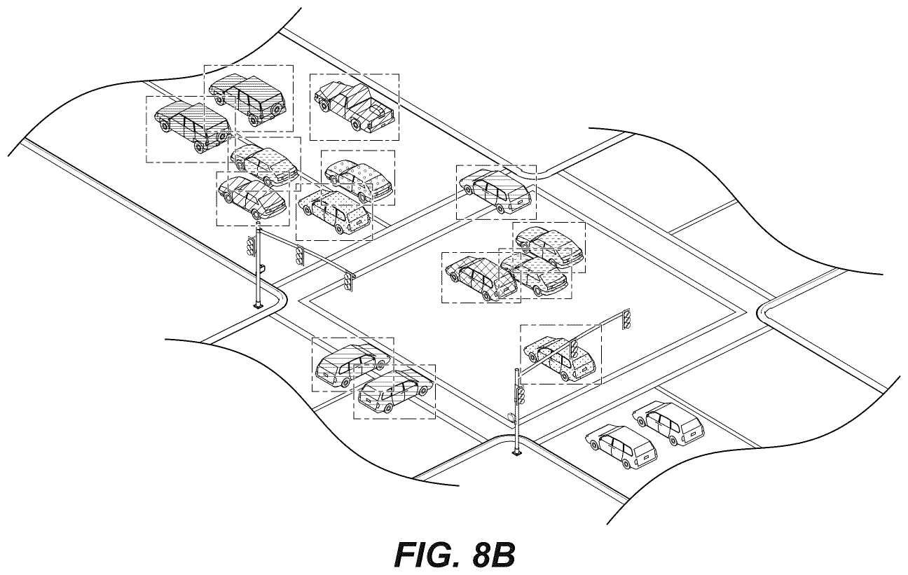

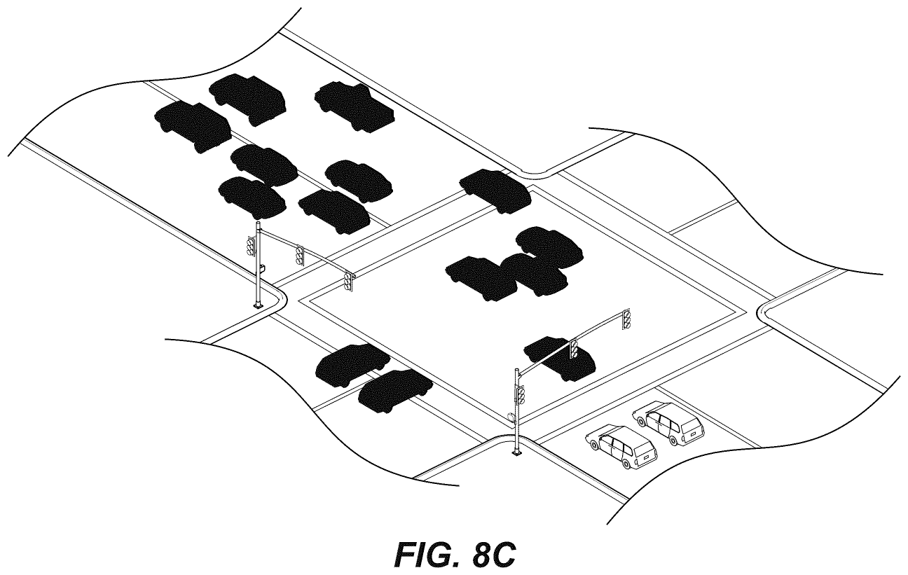

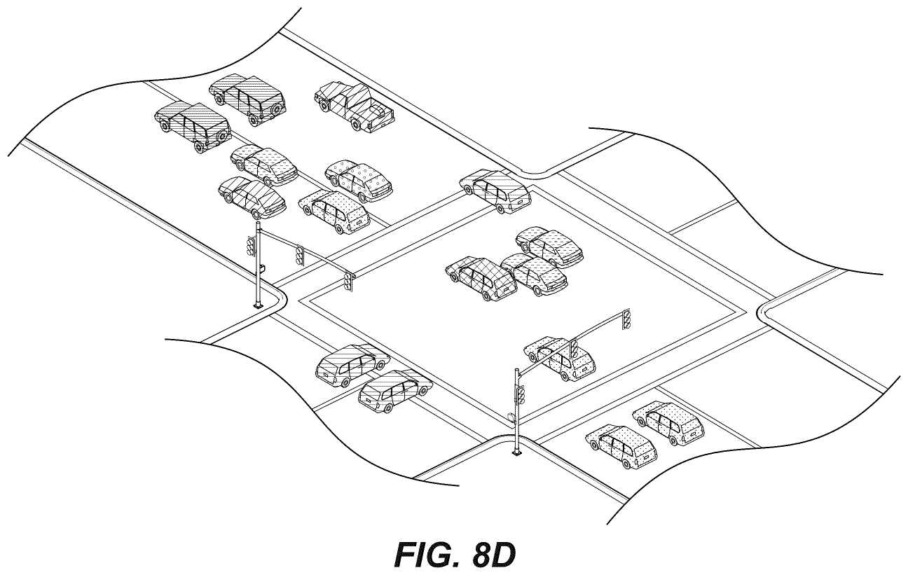

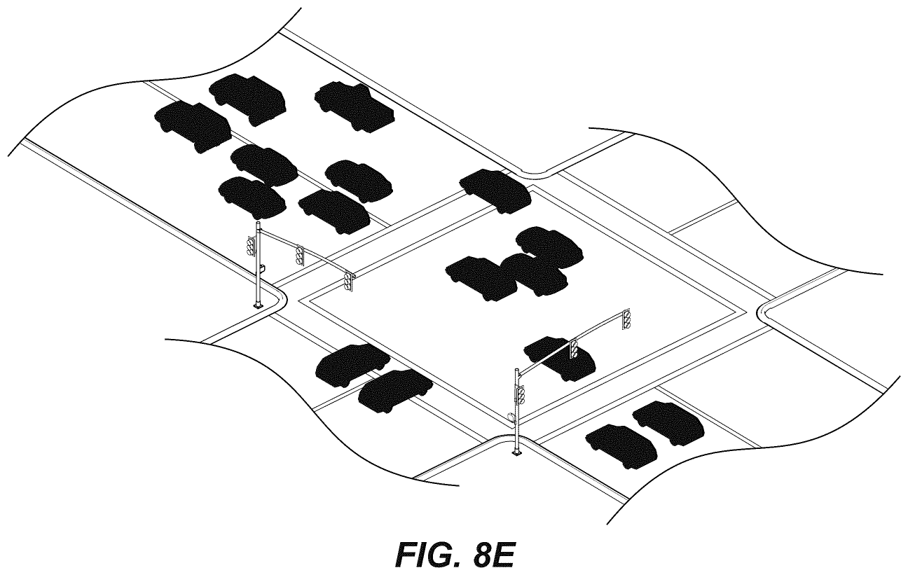

FIG. 8A depicts a flow chart illustrating a third example method for traffic image sensor movement detection and handling. This method may be performed by the systems of FIGS. 9 and/or 10.

At operation 810, an electronic device (such as the analysis device 901 of FIG. 9) may mask out vehicles in a first image and a second image using a mask segmentation model. At operation 820, an electronic device (such as the analysis device 901 of FIG. 9) may perform background extraction on the first image and the second image.

At operation 830, an electronic device (such as the analysis device 901 of FIG. 9) may perform a homography transform on the first image and the second image. An example of such a homography transform is homography from OpenCV (cv2, findHomography with RANSAC+cv2. perspectiveTransform). At operation 840, an electronic device (such as the analysis device 901 of FIG. 9) may estimate a translation using the homography transform.

In various examples, this example method 800 may be implemented as a group of interrelated software modules or components that perform various functions discussed herein. These software modules or components may be executed within a cloud network and/or by one or more computing devices, such as the analysis device 901 of FIG. 9.

Although the example method 800 is illustrated and described as including particular operations performed in a particular order, it is understood that this is an example. In various implementations, various orders of the same, similar, and/or different operations may be performed without departing from the scope of the present disclosure.

For example, operation 840 is illustrated and described as estimating the translation. However, it is understood that this is an example. In some implementations, the evaluation of the translation may be certain and may thus be determined instead of being estimated. Various configurations are possible and contemplated without departing from the scope of the present disclosure.

The methods 600, 700, 800 of FIGS. 6-8 discuss removal of objects and/or removing moving objects, such as vehicles. Such operations may involve using segmentation models like DeepLab, MaskRCNN, Yolov7, Yolov8, and so on.

FIG. 8B depicts an image after performance of MaskRCNN segmentation. FIG. 8C depicts the image of FIG. 8B after removal of foreground moving objects.

FIG. 8D depicts an image after performance of Yolo7 segmentation. FIG. 8E depicts the image of FIG. 8D after removal of foreground moving objects.

Further, as the traffic image sensor may be mostly still, dynamics (such as the dynamics of an intersection may be used in determining background segmentation. This may be usable as vehicles may be moving at speeds that are significant over the course of time in second resolution. Frame differences, such as one second, may be useful in segmenting moving objects. Taking mean and variance over a longer time, such twenty seconds, may give a coarser image. This may also be used as a guiding mask in background extraction.

Although the methods 600, 700, and/or 800 of FIGS. 6-8 illustrate particular techniques for detecting and handling traffic image sensor movement, it is understood that these are examples. In other implementations, other techniques may be used without departing from the scope of the present disclosure.

For example, in some implementations, pixel intensities may be compared between two images by evaluating distance between color values (such as RGB color values) of one or more pixels in the image using a Euclidian distance formula or modification thereof (such as a modification where the distance between color values are not squared). Such distances may be averaged over the pixels evaluated (such as all pixels), normalized, and so on. However, this approach may not handle lighting irregularities (such as caused by different times of day and so on) between the two images as well as the above approaches. Various configurations are possible and contemplated without departing from the scope of the present disclosure.

In another example implementation, a SIFT filter may be used to compare the two images (and/or SIFT for feature extraction and then brute force matching using a matcher such as BruteForce, LIghtGlue (gpu) and so on and/or another feature extractor such as SIFT-SIFT FAST-VGG, DISK (gpu), or SuperPoint (gpu)). This may not be as vulnerable to lighting differences, but may require significantly more hardware and/or software resources and/or time. Various configurations are possible and contemplated without departing from the scope of the present disclosure.

In still another example implementation, a structural similarity index may be used to compare the two images. This may not be as vulnerable to lighting differences, but may require significantly more hardware and/or software resources and/or time. Various configurations are possible and contemplated without departing from the scope of the present disclosure.

In yet another example implementation, an edge detector may be used to compare the two images. This may not be as vulnerable to lighting differences, and may require less more hardware and/or software resources and/or time than some of these alternative approaches, but may still require significantly more hardware and/or software resources and/or time than the techniques discussed above with respect to the methods 600, 700, 800 of FIGS. 6-8. Various configurations are possible and contemplated without departing from the scope of the present disclosure.

In still another example implementation, a combined approach may be used, such as where distances may be calculated between pixel intensities as discussed above after an edge detector has been applied. Various configurations are possible and contemplated without departing from the scope of the present disclosure.

The methods 600, 700, 800 of FIGS. 6-8 and/or other traffic image sensor movement detection and handling may be performed along with analysis of data from traffic sensors. In examples, the methods 600, 700, 800 of FIGS. 6-8 and/or other traffic image sensor movement detection and handling may be performed continuously. This may ensure that any field of view changes are detected and handled immediately. However, this may be extremely burdensome on hardware and/or software resources. In other implementations, the methods 600, 700, 800 of FIGS. 6-8 and/or other traffic image sensor movement detection and handling may be performed periodically (such as once per minute, once per hour, once per day, and so on), in response to detected events, and so on. In various examples, the methods 600, 700, 800 of FIGS. 6-8 and/or other traffic image sensor movement detection and handling may be performed at changing times, such as once every five minutes if no field of view changes have been detected for a time period (such as an hour) and once every thirty seconds if a field of view change has been detected within the time period. Various configurations are possible and contemplated without departing from the scope of the present disclosure.

FIG. 9 depicts a block diagram of a system 900 for traffic image sensor movement detection and handling. The system 900 may include one or more analysis devices 901 (which may be implemented using one or more loud computing arrangements) and/or one or more traffic monitoring devices 902 (such as one or more intersection and/or other still image and/or video cameras, LiDAR sensors, loops, radar, weather data, Internet of Things sensors, fleet vehicles, traffic controllers and/or other city and/or other population area supplied data devices, navigation app data, connected vehicles, and so on). The analysis device 101 may perform one or more of the methods 600, 700, and/or 800 of FIGS. 6-8,

The analysis device 901 and/or one or more other devices may obtain traffic data (such as video from intersection cameras, point cloud data from Light Detection and Ranging (or “LiDAR”) sensors, and so on) from the traffic monitoring device. The analysis device 901 and/or one or more other devices may perform object detection and classification using the data and may determine an output structured data using the detected and classified objects. Alternatively, the analysis device 901 and/or one or more other devices may obtain structured data that has been generated by performing such object detection and classification on traffic data (such as point cloud data from LiDAR sensors). The analysis device 901 and/or one or more other devices may calculate one or more metrics using the structured data. For each frame of traffic data, the analysis device 901 and/or one or more other devices may analyze the metrics to determine various information and/or perform various actions. In some implementations, analysis device 901 and/or one or more other devices may add one or more indicators to the traffic data and/or to one or more visualizations generated using the metrics, the traffic data, the structured data, and so on.

The analysis device 901 and/or one or more other devices may perform object detection and classification using the data. For example, objects may be detected and classified as cars, trucks, buses, pedestrians, light vehicles, heavy vehicles, non-motor vehicles, and so on. Objects may be assigned individual identifiers, identifiers by type, and so on. The analysis device 101 and/or one or more other devices may determine and/or output structured data using the detected and classified objects. The analysis device 901 and/or one or more other devices may calculate one or more metrics using the structured data. For example, the metrics may involve vehicle volume, vehicle volume by vehicle type, average speed, movement status, distance travelled, queue length, pedestrian volume, non-motor volume, light status on arrival, arrival phase, route through intersection, light times, near misses, longitude, latitude, city, state, country, and/or any other metrics that may be calculated using the structured data.

The analysis device 901 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The analysis device 901 may include one or more processors 903 and/or other processing units and/or controllers, one or more non-transitory storage media 904 (which may take the form of, but is not limited to, a magnetic storage medium; optical storage medium; magneto-optical storage medium; read only memory; random access memory; erasable programmable memory; flash memory; and so on), one or more communication units 905, one or more input and/or output devices 906 (such as one or more displays, speakers, keyboards, mice, track pads, touch pads, touch screens, sensors, printers, and so on), and/or other components. The processor 903 may execute instructions stored in the non-transitory storage medium to perform various functions.

Alternatively and/or additionally, the analysis device 901 may involve one or more memory allocations configured to store at least one executable asset and one or more processor allocations configured to access the one or more memory allocations and execute the at least one executable asset to instantiate one or more processes and/or services, such as one or more services, and so on.

Similarly, the traffic monitoring device 902 may be any kind of electronic device. Various configurations are possible and contemplated without departing from the scope of the present disclosure.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service, are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

Although the system 900 is illustrated and described as including particular components arranged in a particular configuration, it is understood that this is an example. In a number of implementations, various configurations of various components may be used without departing from the scope of the present disclosure.

For example, the system 900 is illustrated and described as including the traffic monitoring device 902. However, it is understood that this is an example. In various implementations, the traffic monitoring device 902 may not be part of the system 900. The system 900 may instead communicate with the traffic monitoring device 902. Various configurations are possible and contemplated without departing from the scope of the present disclosure.

Although the above illustrates and describes performance of functions like detection and classification, determination of structured data, and so on, it is understood that this is an example. In various implementations, one or more such functions may be omitted without departing from the scope of the present disclosure.

For example, in some implementations, data that has already been detected and classified may be obtained. Various metrics may be calculated from such, similar to above, which may then be prepared for visualization and/or visualized and/or otherwise used similar to above.

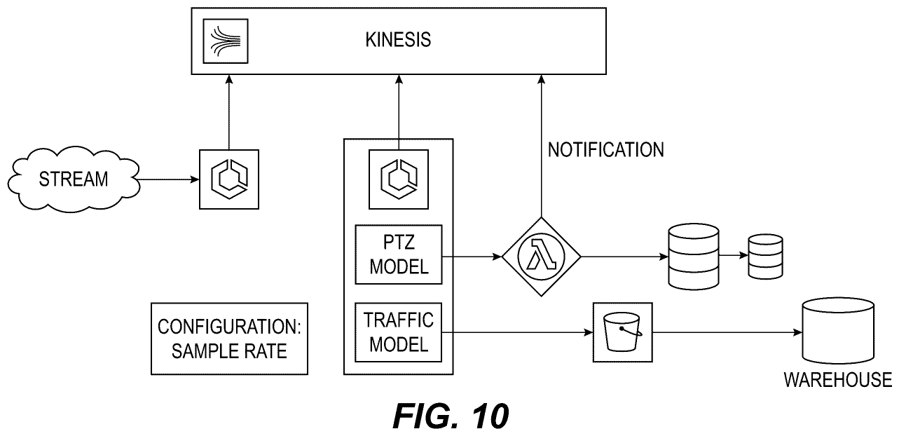

FIG. 10 depicts a diagram of a cloud architecture system for traffic image sensor movement detection and handling. As shown, the data stream comes in and is ingested by cloud services. The PTZ (point tilt zoom) model that is used to perform the traffic image sensor movement detection and handling and the Traffic Model that is used to analyze the data are co-located within the same cloud services consumer module or node so that the traffic image sensor movement detection and the data analysis may be performed at the same time, though the sample rate may be configurable (such as where one frame is processed every second and the first frame is evaluated for traffic image sensor movement detection and handling and traffic image sensor movement detection and handling may not be performed until the expiration of a time period, such as one minute). Output of the traffic image sensor movement detection and handling may be sent as a notification to a system such as Kinesis (a stream based system that allows several different other systems to connect so that messages can be sent across the multiple systems) as well save that information to a data store for later evaluation (such as later adjustment of the PTZ model to better detect and handle traffic movement detection, change the sample rate, and so on). In some examples, the notification may cause another system to not use data from the stream until the traffic image sensor movement returns to a usable position and/or perform another action.

In some implementations, the PTZ model and the Traffic model may be collocated on the same hardware and share the same state. An in memory counter may samples on frame to the desired frame rate. The sample rate may be a default such as every five seconds, the first frame of every bundle, and so on. Another option is to have the producer pull off a frame and send a pointer to that frame in a message so that it is processed by the PTZ model on a separate machine that executes all PTZ functions.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to traffic image sensor movement detection and handling. Moving objects may be removed from first and second images, background extraction may be performed, one or more structural features may be mapped, and a translation may be estimated. If the translation is above a threshold amount, an action may be taken. In some examples, vehicles may be masked out using a mask segmentation model, background extraction may be performed, a homography transform may be performed, and a translation may be estimated.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for traffic image sensor movement detection and handling, comprising:
at least one non-transitory storage medium storing instructions; and
at least one processor that executes the instructions to:
mask out vehicles in a first image and a second image using a mask segmentation model;
perform background extraction on the first image and the second image;
perform a homography transform on the first image and the second image;
estimate a translation using the homography transform;
determine whether the translation is over a threshold amount; and
upon determining that the translation is over the threshold amount, take an action.

2. The system of claim 1, wherein, upon determining that the translation is not over the threshold amount, the at least one processor further executes the instructions to omit taking the action.

3. The system of claim 1, wherein the at least one processor further executes the instructions to estimate the translation periodically.

4. The system of claim 3, wherein the period at least one of is one minute or changes.

5. The system of claim 1, wherein the at least one processor executes the instructions using cloud services.

6. The system of claim 1, wherein the mask segmentation model comprises at least one of DeepLab, MaskRCNN, Yolov7, or Yolov8.

7. The system of claim 1, wherein the translation is at least one of in pixels or an absolute pixel movement.

8. The system of claim 1, wherein the action comprises flagging data associated with the traffic image sensor as not to be used.

9. The system of claim 8, wherein the at least one processor further executes the instructions to unflag the data upon estimating that the translation is reversed.

10. The system of claim 1, wherein the action comprises transmitting an instruction to move the traffic image sensor.

11. The system of claim 10, wherein the at least one processor further executes the instructions to transmit the instruction to the traffic image sensor.

12. The system of claim 1, wherein the action comprises compensating for the translating when using data associated with the traffic image sensor for analysis.

13. The system of claim 1, wherein an area of interest is no longer visible when the translation is over the threshold amount.

14. The system of claim 13, wherein the area of interest comprises an intersection, an approach to the intersection, or an exit from the intersection.

15. The method of claim 1, wherein the threshold amount is at least one of:
a number of feet; or
a number of pixels.

16. A method of method of traffic image sensor movement detection and handling, comprising:
masking out vehicles in a first image and a second image using a mask segmentation model;
performing background extraction on the first image and the second image;
performing a homography transform on the first image and the second image;
estimating a translation using the homography transform;
outputting information about the translation;
determining whether the translation is over a threshold amount; and
upon determining that the translation is over the threshold amount, taking an action.

17. The method of claim 16, wherein the information is output on the second image.

18. The method of claim 16, wherein the information comprises an indicator showing an amount of the translation or a position of the first image in the second image.

19. A computer program product, comprising:
first instructions stored in at least one non-transitory machine readable medium an executable by at least one processor to mask out vehicles in a first image and a second image using a mask segmentation model;
second instructions stored in the at least one non-transitory machine readable medium an executable by the at least one processor to perform background extraction on the first image and the second image;
third instructions stored in the at least one non-transitory machine readable medium an executable by the at least one processor to perform a homography transform on the first image and the second image;
fourth instructions stored in the at least one non-transitory machine readable medium an executable by the at least one processor to estimate a translation using the homography transform;
fifth instructions stored in the at least one non-transitory machine readable medium an executable by the at least one processor to determine whether the translation is over a threshold amount; and
sixth instructions stored in the at least one non-transitory machine readable medium an executable by the at least one processor to, upon determining that the translation is over the threshold amount, take an action.

20. The computer program product of claim 19, wherein the action comprises transmitting an instruction to move the traffic image sensor.
